(19) United States
(12) Patent Application Publication
(10) Pub. No.: US 2023/0017845 A1
(43) Pub. Date: Jan. 19, 2023

(54) POWER STORAGE MODULE

(71) Applicant: Panasonic Intellectual Property Management Co., Ltd., Osaka (JP)

(72) Inventor: HIROSHI TAKASAKI, Osaka (JP)

(21) Appl. No.: 17/757,590

(22) PCT Filed: Dec. 22, 2020
(86) PCT No.: PCT/JP2020/047887

§ 371 Date: Jun. 17, 2022

(30) Foreign Application Priority Data
Dec. 27, 2019 (JP) 2019-239587

(51) Int. Cl. H01M 50/213; H01M 50/107; H01M 50/152; H01M 50/262; H01M 50/222

(52) U.S. Cl. CPC H01M 50/213; H01M 50/107; H01M 50/152; H01M 50/262; H01M 50/222

(57) ABSTRACT

A power storage module includes a plurality of power storage devices (for example, secondary batteries) arranged side by side and a holder having a container that contains the plurality of power storage devices. The holder includes a first holder and a second holder. Each of the plurality of power storage devices includes a first end and a second end. The first end is contained in the first holder and the second end is contained in the second holder. In the holder, resin is disposed in at least one of a space between the plurality of power storage devices and a space between the power storage device and the holder. The holder is provided with a gap defined by at least the resin and the holder and communicating with the outside of the holder.

### TECHNICAL FIELD

The present disclosure relates to a power storage module.

### BACKGROUND ART

A power storage module including a plurality of power storage devices such as secondary batteries is used in various applications such as electric tools, power-assisted bicycles, electric motorcycles, hybrid electric vehicles, and electric vehicles. As a method of holding a plurality of power storage devices in a power storage module, it is known a method of holding an outer periphery of each power storage device while covering it with a potting resin (PTL 1).

### CITATION LIST

### Patent Literature

PTL 1: Unexamined Japanese Patent Publication No. 2012-028244

### SUMMARY OF THE INVENTION

### Technical Problem

As described above, use of the potting material makes it possible to hold a plurality of power storage devices at a constant strength. However, this resin disposed around each power storage device is likely to generate gas when overheated. At this time, when this resin is contained together with the power storage device in a state of being sealed in a container such as a holder, there is a possibility that the gas accumulated in the container acts as a force for moving the power storage device. In such a situation, an object of the present disclosure is to provide a power storage module having excellent reliability.

### Solution to Problem

One aspect of the present disclosure relates to a power storage module. A power storage module is a power storage module including: a plurality of power storage devices arranged side by side; and a holder having a container that contains the plurality of power storage devices, in which the holder includes a first holder and a second holder, each of the plurality of power storage devices includes a first end in a height direction perpendicular to a direction of arrangement, a second end opposite to the first end, the first end is contained in the first holder, and the second end is contained in the second holder, in the holder, a resin is disposed in at least one space selected from a group including a space between the plurality of power storage devices and a space between the power storage device and the holder, and the holder is provided with a gap defined by at least the resin and the holder and communicating with an outside of the holder.

### Advantageous Effect of Invention

According to the power storage module of the present disclosure, it is possible to suppress sealing of the resin in the holder. Therefore, the gas generated in the holder is easily discharged, and the reliability of the power storage module is enhanced.

### BRIEF DESCRIPTION OF THE DRAWINGS

FIG. 1 is a perspective view schematically illustrating a main part of a power storage module of the present disclosure.

FIG. 2 is a view schematically illustrating a part of the main part illustrated in FIG. 1.

FIG. 3 is a perspective view schematically illustrating another part of the main part illustrated in FIG. 1.

FIG. 4 is a perspective view schematically illustrating another part of the main part illustrated in FIG. 1.

FIG. 5 is a partially exploded cross-sectional view schematically illustrating an example of a secondary battery used in the power storage module illustrated in FIG. 1.

FIG. 6 is a cross-sectional view taken along line VI-VI in FIG. 1.

### DESCRIPTION OF EMBODIMENT

Hereinafter, exemplary embodiments of the present disclosure will be described. In the following description, exemplary embodiments of the present disclosure will be described by way of examples, but the present disclosure is not limited to the examples described below. In the following description, specific numerical values and materials may be exemplified, but other numerical values and other materials may be applied as long as the effect of the present disclosure can be obtained.

### Power Storage Module

A power storage module of the present disclosure includes a plurality of power storage devices arranged side by side, and a holder having a container that contains the plurality of power storage devices. The holder includes a first holder and a second holder. Each of the plurality of power storage devices includes a first end in a height direction perpendicular to a direction of arrangement, and a second end opposite to the first end. The first end is contained in the first holder and the second end is contained in the second holder. In the holder, a resin is disposed in at least one space selected from a group including a space between the plurality of power storage devices and a space between the power storage device and the holder. This resin (resin part) may be referred to as “resin (R)” below. The holder is provided with a gap defined by at least resin (R) and the holder and communicating with the outside of the holder. This gap may be referred to as “gap (G)” below.

In the power storage module of the present disclosure, resin (R) is disposed in at least one space selected from a group including a space between the plurality of power storage devices and a space between the power storage device and the holder. Therefore, a function of fixing the power storage device together with the holder is achieved.

Gap (G) communicates with the outside of the holder. Therefore, even when gas is released into gap (G) due to decomposition of the resin or an additive contained in the resin from resin (R) overheated in a state where the battery is overheated, the gas is released to the outside of the holder. Therefore, it is possible to suppress occurrence of a problem such as movement of the battery due to an increase in pressure in the holder.

The amount of resin (R) can be reduced by providing gap (G) as compared with a case where the space between the first holder and the second holder is entirely filled with resin (R). As a result, it is possible to reduce the weight of the power storage module. Furthermore, reduction in the amount of resin (R) also facilitates the process of disposing resin (R) in the space between the power storage devices or the space between the holder and the power storage device. For example, the time and cost for disposing resin (R) can be reduced.

The orientations of the plurality of power storage devices may be the same or may be different. For example, when the power storage device is a secondary battery having a positive-electrode terminal at one end, the ends of all the secondary batteries near the positive-electrode terminal may be contained in the first holder, or the ends of all the secondary batteries near the positive-electrode terminal may be contained in the second holder. Alternatively, some of the ends of all the secondary batteries near the positive-electrode terminal may be contained in the first holder, and the remaining ends near the positive-electrode terminal may be contained in the second holder.

In the holder, resin (R) is disposed in at least one of the space between the plurality of power storage devices and the space between the power storage device and the holder. Resin (R) may be disposed in the space between the plurality of power storage devices, may be disposed in the space between the power storage device and the holder, or may be disposed in both of the two spaces. Note that “resin (R) is disposed in the space” means that resin (R) is disposed in at least a part of the space, and it is not necessary that the entire space is filled with resin (R).

The power storage device is not particularly limited, and any secondary battery, capacitor, or the like can be used. For example, a known non-aqueous electrolyte secondary battery (known lithium ion secondary batteries, known lithium batteries, and the like), a known nickel-metal hydride secondary battery, or the like may be used. As the capacitor, an electric double layer capacitor using activated carbon as an electrode material, a lithium ion capacitor, or the like can also be used. The negative electrode of the lithium ion secondary battery of one example contains, as a negative-electrode active material, a substance that reversibly occludes and releases lithium ions. The negative electrode of the lithium secondary battery of one example is an electrode in which lithium metal is deposited during charge, and the deposited lithium metal is released during discharge. The positive electrode of the secondary battery may contain a composite oxide containing lithium as a positive-electrode active material.

Each of the plurality of power storage devices is disposed such that the longitudinal directions are along one direction. In other words, the longitudinal directions of the plurality of power storage devices are parallel to one another (including a case where the longitudinal directions are substantially parallel to one another). Here, the longitudinal direction is a direction parallel to a central axis of a tubular part (for example, a cylindrical part) of an outer covering body of the power storage device. In a typical example, the plurality of power storage devices are disposed such that the first ends of the plurality of power storage devices are disposed on one virtual plane. Two ends on both sides of the power storage device in the longitudinal direction are contained in the first holder and the second holder, respectively.

The first and second holders are usually formed using an insulating resin or the like. As the insulating resin, a resin used as a material of a holder of a conventional power storage module may be used. Examples thereof include a thermosetting resin and a thermoplastic resin. Examples of the insulating resin include polycarbonate. The first and second holders can be formed, for example, by injection molding or the like. The holder may be made of metal as long as insulation with the power storage device can be maintained.

The first holder may have a first container in which the first end of the power storage device is contained, and the second holder may have a second container in which the second end of the power storage device is contained. The first holder usually has a plate-like part having the first container, and the first container contains the first end of the power storage device. Similarly, the second holder usually has a plate-like part having the first container, and the second container contains the second end of the power storage device. For example, the first and second ends are inserted and held in a recess (for example, a hole) or the like that is the container formed in the plate-like parts of the first and second holders.

As resin (R) disposed in the space between the plurality of power storage devices or the space between the power storage device and the holder, for example, a resin that can be filled in the space and is cured after filling can be used. Resin (R) may be a resin that is cured by mixing two components. Examples of resin (R) include a urethane resin (polyurethane), an epoxy resin, and a silicone resin. The urethane resin is obtained by mixing a polyol component (first material) and a polyisocyanate component (second material). These components are in a liquid state immediately after being mixed, but the reaction proceeds as time elapses, and a cured urethane resin is obtained. The urethane resin can impart various properties (heat transfer property, heat absorption property (flame retardancy), insulation property, and the like) by selecting a component to be a raw material and adding an additive. Therefore, the urethane resin can be used as resin (R). As resin (R), a known two-liquid mixed type resin may be used. For example, a known urethane resin (two-liquid mixed type urethane resin) used for sealing a substrate or the like may be used as resin (R). Some of these resins may be referred to as potting resin.

Usually, resin (R) is in contact with the inner surface of the first holder. In other words, resin (R) is usually contained in the first holder. A part of resin (R) may be in contact with the second holder. Alternatively, resin (R) may be disposed so as not to be in contact with the second holder. When resin (R) is also contained in (in contact with) the second holder, the amount of resin (R) contained in the first holder may be larger than the amount of resin (R) contained in the second holder. Alternatively, the ratio of resin (R) occupying the gap between the first holder and the power storage device may be higher than the ratio of resin (R) occupying the gap between the second holder and the power storage device. By disposing resin (R) in this manner, it is possible to reduce the amount of resin (R) in particular. Furthermore, according to this configuration, when gas is released from resin (R), the gas can be quickly released to the outside of the holder.

The area of the surface in contact with resin (R) among the side surfaces of the power storage device may be in a range from 50% to 100% (for example, in a range from 70% to 100% or in a range from 80% to 100%) of the area of the side surface of the secondary battery. The upper limit of these ranges may be less than or equal to 98% or less than or equal to 95%.

Each of the plurality of power storage devices may include an outer covering body having a bottomed cylindrical shape. The outer covering body may have a ring-shaped groove formed near one end (for example, a first end). An example of the power storage device in this case is a cylindrical secondary battery. Examples of such cylindrical secondary battery include a cylindrical lithium ion secondary battery, a cylindrical lithium secondary battery, and a cylindrical nickel-metal hydride secondary battery.

In the power storage module of the present disclosure, resin (R) may be in contact with the first holder, each of the plurality of power storage devices may include the outer covering body having a bottomed cylindrical shape, and the outer covering body may have the ring-shaped groove formed near the first end. That is, the groove may be formed at a position closer to the first end than the second end. An electrode group including a positive electrode and a negative electrode is disposed on the outer covering body. In the power storage device, there is a case where the outer covering body is provided with a groove. The groove is usually formed for the purpose of disposing a sealing body to seal an opening of the outer covering body. In such a power storage device, the sealing body is electrically connected to one electrode in the electrode group to function as a terminal (for example, a positive-electrode terminal), and the outer covering body is electrically connected to the other electrode in the electrode group to function as a terminal (for example, a negative-electrode terminal). The sealing body including the positive-electrode terminal is usually provided with a mechanism for releasing gas inside the battery when the internal pressure of the battery increases. A conventionally-used known mechanism may be applied to the mechanism.

The plurality of power storage devices may be arranged in a staggered manner or may be arranged in another arrangement manner. The staggered arrangement can increase the number of batteries per unit volume. An example of the staggered arrangement will be described later. Usually, the plurality of power storage devices are disposed so as not to be in contact with each other.

The holder may have a through-hole, and gap (G) may communicate with the outside of the holder through the through-hole. The through-hole may be formed in at least one part selected from the first holder, the second holder, and between the first holder and the second holder. In an example, the through-hole is formed between the first holder and the second holder.

The first holder may include an outer wall disposed to surround the plurality of power storage devices. The through-hole of the holder may be formed in at least one part selected from the group including between the first holder and the second holder and the outer wall. In this case, the first holder may include a plate-shaped part (flat plate-shaped part) and an outer wall extending from a peripheral edge of the plate-shaped part. The upper and lower surfaces of the holder are provided with the sealing body used for drawing the electrode and a bottom of the outer covering body used for cooling. On the side surface of the holder, another member is less likely to cover the holder than on the upper and lower surfaces of the holder, and thus gas can be more efficiently released.

Various other components (for example, additives) may be added to resin (R) as necessary. For example, resin (R) may contain particles containing an inorganic substance that decomposes by an endothermic reaction. Examples of such inorganic substances include aluminum hydroxide and magnesium hydroxide. Examples of particles containing such an inorganic substance include an inorganic filler made of aluminum hydroxide and an inorganic filler made of magnesium hydroxide. By using resin (R) containing these inorganic substances, it is possible to effectively suppress temperature rise of the battery when the battery is overheated.

The module of the present disclosure includes another configuration element as necessary. For example, the module of the present disclosure usually includes a positive-electrode conducting member and a negative-electrode conducting member connected to the positive-electrode terminal and the negative-electrode terminal, respectively, for charging and discharging. The positive-electrode conducting member and the negative-electrode conducting member may be disposed on different sides, or may be disposed on the same side. For example, when the positive-electrode terminal is disposed near the first holder, the positive-electrode conducting member may be disposed near the first holder, and the negative-electrode conducting member may be disposed near the second holder. Alternatively, when the positive-electrode terminal is disposed near the first holder, both the positive-electrode conducting member and the negative-electrode conducting member may be disposed near the first holder. Alternatively, when some of the plurality of positive-electrode terminals are disposed near the first holder and the remaining positive-electrode terminals are disposed near the second holder, both the positive-electrode conducting member and the negative-electrode conducting member may be disposed near the first holder sand near the second holder. Since these arrangement methods and conducting members used for it have been conventionally proposed, they may be used.

The module of the present disclosure usually includes an outer case that stores the holder. Usually, the outer case is provided with a through-hole communicating with the outside of the outer case. Gap (G) (gap communicating with the outside of the holder) between resin (R) and the second holder can communicate with the outside of the outer case through the through-hole of the outer case.

Usually, a space exists between the outer case and the plate-shaped part of the first holder. This space can be provided with the conducting member. Since this space normally communicates with the outside of the outer case, when the internal pressure of the battery increases and gas is released from the battery, the gas can be released to the outside of the outer case through the space.

Hereinafter, an example of the power storage module of the present disclosure will be specifically described with reference to the drawings. The above-described configuration elements can be applied to the configuration elements of a power storage module as an example described below. The configuration elements of the power storage module of one example described below can be changed based on the above description. Matters to be described below may be applied to the above-described exemplary embodiment. In the following drawings, reference numerals may be omitted in order to make the drawings easily viewable.

Hereinafter, as an example, a power storage module including a battery group including a plurality of cylindrical secondary batteries and a holder that holds the plurality of secondary batteries will be described. The power storage module of this example has the following configuration. That is, the holder includes the first holder having the first container and the second holder having the second container. Each of the plurality of secondary batteries includes the first end and the second end opposite to the first end. The first end is contained in the first container and the second end is contained in the second container. The space between the plurality of secondary batteries is provided with resin (R). Between resin (R) and the second holder, gap (G) communicating with the outside of the holder is present.

### First Exemplary Embodiment

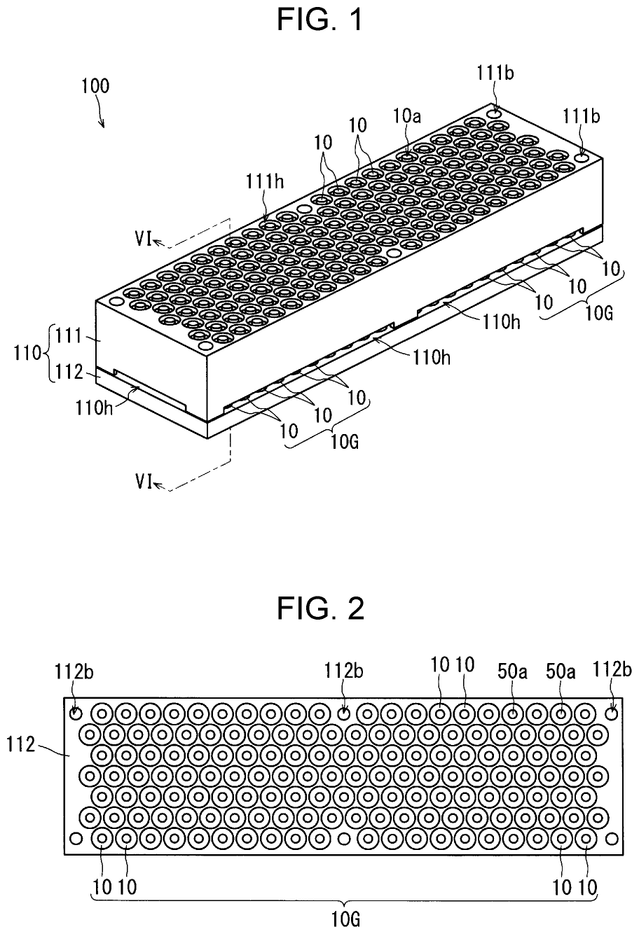

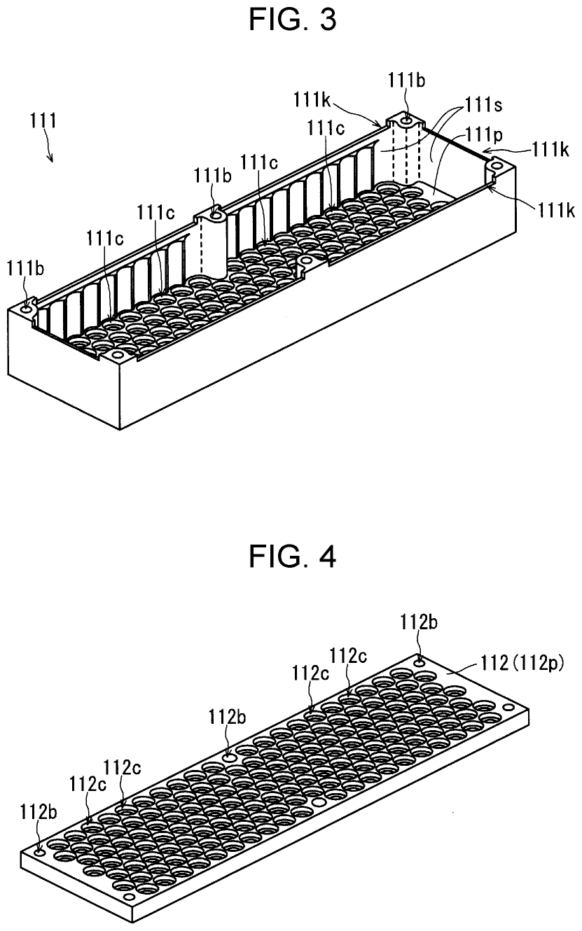

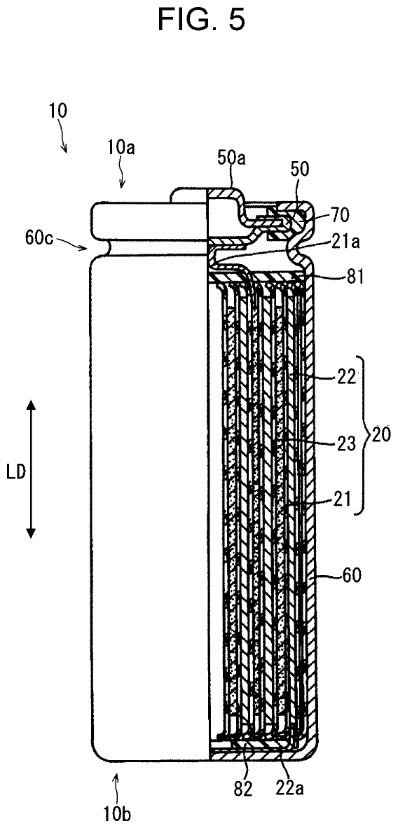

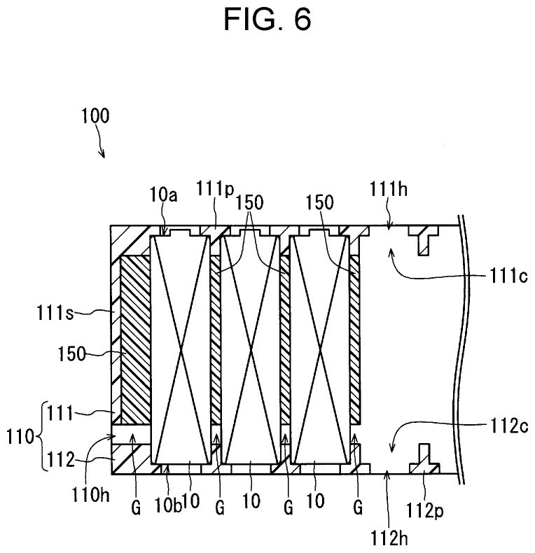

FIG. 1 illustrates a perspective view of a main part of power storage module 100 of a first exemplary embodiment. As an example of the plurality of power storage devices, power storage module 100 includes battery group 10G including the plurality of secondary batteries 10 arranged side by side, and holder 110 that contains secondary batteries 10. Holder 110 includes first holder 111 and second holder 112. FIG. 2 illustrates a view of battery group 10G and second holder 112 as viewed from first holder 111. FIG. 3 illustrates a perspective view of first holder 111 as viewed from second holder 112. FIG. 4 illustrates a perspective view of second holder 112 as viewed from first holder 111. FIG. 5 illustrates a partially exploded cross-sectional view of secondary battery 10. FIG. 6 is a cross-sectional view taken along line VI-VI in FIG. 1. Power storage module 100 includes an outer case that stores holder 110 and a conducting member connected to the positive-electrode terminal and the negative-electrode terminal of secondary battery 10, but the illustration is omitted.

As described later, each of the plurality of secondary batteries 10 includes first end 10a and second end 10b opposite to first end 10a. First end 10a is contained (held) in first holder 111, and second end 10b is contained (held) in second holder 112. First holder 111 and second holder 112 are fixed to each other by bolts or the like through through-hole 111b and through-hole 112b to be described later. Although through-holes 111b and 112b are fixed at the peripheral edge of the holder in the alignment direction of battery group 10G, the present invention is not limited to this configuration, and they may be fixed at the center of the holder. This configuration makes it possible to further expand the opening area of through-hole 110h.

Referring to FIG. 1, the outer wall of holder 110 is provided with through-hole 110h. Through-hole 110h is formed between first holder 111 and second holder 112.

First holder 111 is provided with through-hole 111h through which first end 10a side of each of the plurality of secondary batteries 10 is exposed. In the example illustrated in FIG. 1, positive-electrode terminal 50a exists first end 10a of secondary battery 10.

Referring to FIG. 2, the plurality of secondary batteries 10 are arranged in a staggered manner. Specifically, a plurality of rows each including the plurality of secondary batteries 10 are arranged side by side in a column direction perpendicular to the row. In each row, the plurality of secondary batteries 10 are arranged at substantially equal intervals in the row direction. In two adjacent rows, the positions of secondary batteries 10 are shifted in the row direction. Two adjacent rows with one row interposed therebetween have the same position of secondary battery 10 in the row direction. In one example, the staggered arrangement is an arrangement in which hexagons of the same shape are arranged so as to fill the plane without a gap, and secondary batteries 10 are placed at the apex of the hexagon and the center of the hexagon. As illustrated in FIG. 2, a space exists between the plurality of secondary batteries 10. The plurality of secondary batteries 10 are disposed so as not to be in contact with one another.

Referring to FIG. 3, first holder 111 includes plate-shaped part 111p having a flat plate shape and outer wall (side wall) 111s extending from a peripheral edge of plate-shaped part 111p. As illustrated in FIG. 1, battery group 10G is surrounded by outer wall 111s. Outer wall 111s is provided with cutout 111k substantially over the entire circumference. Cutout 111k serves as through-hole 110h illustrated in FIG. 1.

Plate-shaped part 111p is provided with a plurality of recesses (first containers) 111c arranged in a staggered manner. The center of recess 111c is provided with a through-hole (through-hole 111h illustrated in FIG. 1). First end 10a of secondary battery 10 is contained in recess 111c, and first end 10a is held by first holder 111.

Referring to FIG. 4, second holder 112 includes plate-shaped part 112p having a flat plate shape. Second holder 112 (plate-shaped part 112p) is provided with a plurality of recesses (second containers) 112c arranged in a staggered manner. The center of recess 112c is provided with a through-hole (through-hole 112h in FIG. 6). Second end 10b of secondary battery 10 is contained in recess 112c, and second end 10b is held by second holder 112. Second holder 112 is provided with fixing through-hole 112b.

Referring to FIG. 5, the plurality of cylindrical secondary batteries 10 include first end 10a and second end 10b opposite to first end 10a. First end 10a and second end 10b are two ends in longitudinal direction LD of secondary battery 10. The orientations of the batteries at the ends of the plurality of secondary batteries 10 (for example, which direction the sealing body is oriented) may be the same or different among the individual batteries. Longitudinal direction LD is a height direction of secondary battery 10. In power storage module 100, longitudinal direction LD is a direction perpendicular to a direction in which the plurality of secondary batteries 10 are arranged side by side.

Here, as an example, a case where secondary battery 10 is a lithium ion secondary battery will be described. The configuration elements of secondary battery 10 described below are not particularly limited, and known ones may be applied. Secondary battery 10 includes wound electrode group 20 and a non-aqueous electrolyte (not illustrated). Electrode group 20 includes strip-shaped positive electrode 21, strip-shaped negative electrode 22, and separator 23. Separator 23 is disposed between positive electrode 21 and negative electrode 22. Positive-electrode lead 21a is connected to positive electrode 21. Negative-electrode lead 22a is connected to negative electrode 22. Positive electrode 21 includes a positive-electrode current collector and a positive-electrode active material layer disposed on the positive-electrode current collector. Negative electrode 22 includes a negative-electrode current collector and a negative-electrode active material layer disposed on the negative-electrode current collector.

One end of positive-electrode lead 21a is connected to positive electrode 21, and the other end is connected to sealing body 50. Sealing body 50 includes positive-electrode terminal 50a. Usually, sealing body 50 includes a mechanism that operates as a safety valve when the internal pressure of the battery increases.

One end of negative-electrode lead 22a is connected to negative electrode 22, and the other end is connected to the bottom of outer covering body 60. Outer covering body 60 functions as a negative-electrode terminal. Outer covering body 60 is a bottomed cylindrical can. Outer covering body 60 has ring-shaped groove 60c formed near first end 10a.

Upper insulating ring 81 and lower insulating ring 82 made of resin are disposed in the upper part and a lower part of electrode group 20, respectively. Outer covering body 60 is sealed by sealing body 50 and gasket 70. Outer covering body 60, sealing body 50, and gasket 70 constitute a battery case, and electrode group 20 and the non-aqueous electrolyte are disposed inside the battery case.

FIG. 6 is a cross-sectional view taken along line VI-VI in FIG. 1. For easy understanding, illustration of secondary battery 10 at the right end is omitted. In FIG. 6, illustration of groove 60c of secondary battery 10 is omitted.

Through-hole 110h is formed between first holder 111 and second holder 112. First holder 111 (plate-shaped part 111p) has recess 111c and through-hole 111h formed at the center of recess 111c. Second holder 112 (plate-shaped part 112p) has recess 112c and through-hole 112h formed at the center of recess 112c. A conducting member for charge and discharge is connected to the electrode terminal through through-hole 111h (alternatively, through-holes 111h and 112h).

First end 10a of secondary battery 10 is disposed in recess 111c, and second end 10b of secondary battery 10 is disposed in recess 112c. Usually, a part where first holder 111 and secondary battery 10 are in contact with each other and a part where second holder 112 and the secondary battery are in contact with each other are fixed with an adhesive or the like.

Resin 150 is filled (disposed) in the space between the plurality of secondary batteries 10. Resin 150 holding secondary battery 10 together with holder 110 is in contact with first holder 111 (the inner surface of first holder 111). On the other hand, resin 150 is not in contact with second holder 112. There is gap G between resin 150 and second holder 112. Gap G communicates with a space outside holder 110 through through-hole 110h. Gap G is defined by at least resin 150 and holder 110.

The direction in which the power storage module is disposed when power storage module 100 is used is not particularly limited. For example, power storage module 100 may be used with second holder 112 disposed downward and first holder 111 disposed upward. That is, power storage module 100 may be disposed and used such that longitudinal direction LD of secondary battery 10 is the vertical direction. Alternatively, power storage module 100 may be disposed and used such that longitudinal direction LD of secondary battery 10 is inclined with respect to the vertical direction. For example, power storage module 100 may be disposed and used such that longitudinal direction LD of secondary battery 10 is the horizontal direction.

In power storage module 100, gap G communicating with the outside of holder 110 exists. Therefore, even in a case where gas is released from resin 150 due to heat generation of secondary battery 10 or the like, the gas can be released to the outside of holder 110 through gap G. Since the part of gap G is not filled with resin 150, the weight of power storage module 100 can be reduced as compared with the power storage module in which the entire secondary battery 10 is covered with resin 150.

When gap G does not exist, the amount of resin 150 is large, so that the power storage module becomes heavy. In a case where secondary battery 10 is overheated and gas is released from resin 150, there is no route for releasing the gas to the outside of the holder. Therefore, the pressure in the holder increases, and deformation of the holder or movement of secondary battery 10 may occur. According to the present disclosure, the possibility that these problems occur can be reduced.

### Manufacturing Method for Power Storage Module 100

There is no particular limitation in manufacturing method for the power storage module of the present disclosure. A manufacturing example for power storage module 100 will be described below. First, members necessary for manufacturing power storage module 100 are prepared. First and second holders 111 and 112 can be formed, for example, by injection molding a resin as a material. Next, first holder 111 is placed such that plate-shaped part 111p of first holder 111 comes downward. Next, first end 10a of secondary battery 10 is inserted into recess 111c of first holder 111. At this time, first holder 111 and first end 10a are fixed with an adhesive or the like. Next, the space between the plurality of secondary batteries 10 is filled with resin 150 before cured. At this time, resin 150 before cured is filled up to a position not exceeding cutout 111k (see FIG. 3) of first holder 111.

As compared with a case where the entirety between first holder 111 and second holder 112 is filled with resin 150, power storage module 100 is small in the depth of filling with resin 150 and the filling amount of resin 150 is small. Therefore, resin 150 can be easily filled.

After resin 150 is cured, first holder 111 and second holder 112 are combined and fixed to obtain holder 110. At this time, second end 10b of secondary battery 10 is inserted into recess 112c of second holder 112. Then, second holder 112 and second end 10b are fixed with an adhesive or the like. Next, a conducting member for charging and discharging is connected to the electrode terminal. Holder 110 on which the conducting member is disposed is fixed to the outer case, and wiring or the like is performed as necessary. Thus, power storage module 100 is obtained.

### INDUSTRIAL APPLICABILITY

The present disclosure is applicable to a power storage module.

### REFERENCE MARKS IN THE DRAWINGS

10 secondary battery (power storage device)
10a first end
10b second end
10G battery group
60 outer covering body
60c groove
100 power storage module
110 holder
111 first holder
111c recess (first container)
111h through-hole
111s outer wall
112 second holder
112c recess (second container)
150 resin
G gap

1. A power storage module comprising:
a plurality of power storage devices arranged side by side; and
a holder including a container that contains the plurality of power storage devices,
wherein
the holder includes a first holder and a second holder,
each of the plurality of power storage devices includes a first end in a height perpendicular to a direction of the arrangement of the plurality of power storage device and a second end opposite to the first end,
the first end is contained in the first holder, and the second end is contained in the second holder,
in the holder, a resin is disposed in at least one space selected from a group including a space between the plurality of power storage devices and a space between the power storage devices and the holder, and
the holder is provided with a gap inside defined by at least the resin and the holder and communicating with an outside of the holder.

2. The power storage module according to claim 1, wherein the resin is in contact with an inner surface of the first holder.

3. The power storage module according to claim 1, wherein the resin is disposed not to be in contact with the second holder.

4. The power storage module according to claim 1, wherein
the holder includes a through-hole, and
the gap communicates with an outside of the holder through the through-hole.

5. The power storage module according to claim 4, wherein
the first holder includes an outer wall disposed to surround the plurality of power storage devices, and
the through-hole is in at least one part selected from a group including between the first holder and the second holder and the outer wall.

6. The power storage module according to claim 1, wherein the resin contains particles containing an inorganic substance that decomposes by an endothermic reaction.
